(19) United States
(12) Patent Application Publication
(10) Pub. No.: US 2024/0192942 A1
(43) Pub. Date: Jun. 13, 2024

(54) LAYERED CONTAINER SOFTWARE UPDATES IN RESOURCE-CONSTRAINED EDGE DEVICES

(71) Applicant: Intrinsic Innovation LLC, Mountain View, CA (US)

(72) Inventors: Stefan Sauer, Neufahrn (DE); Fanmin Shi, Munich (DE); Rodrigo James Everett Queiro, Munich (DE)

(21) Appl. No.: 18/062,792

(22) Filed: Dec. 7, 2022

(51) Int. Cl. G06F 8/65; G06F 9/455

(52) U.S. Cl. CPC G06F 8/65; G06F 9/45558; G06F 2009/45562

(57) ABSTRACT

Methods, systems, and media for a computing device comprising; receiving a plurality of container snapshots for operating an edge device, wherein the container snapshots include an operating system (OS) snapshot and a plurality of application snapshots; writing the OS snapshot into a read-only partition; writing the plurality of application snapshots into a writable partition as a plurality of overlay mounted container snapshot layers; obtaining metadata for each of the plurality of application snapshots; generating a merged collection of metadata using the metadata for each of the plurality of snapshots; executing the OS snapshot including a container runtime tool; and executing, using the container runtime tool, one or more containers using the plurality of overlay mounted container snapshot layers.

### BACKGROUND

This specification relates to running resource-constrained edge devices.

In this specification, a resource-constrained edge device is a device that is used to control an industrial process, such as a control system for a robotics installation. Edge devices generally need to operate with high availability and as deterministically as possible, which means that the processes running on the edge device have tight and bounded wait times. For this reason, many edge devices do not have an Internet connection because relying on an Internet connection can introduce unbounded wait times or change the behavior of the device depending on the quality of the connection.

Edge devices often need to run for long periods of time without a restart, e.g., a robotics process may run nonstop for days or weeks at a time to drive robots to manufacture items. In addition, the hardware supporting an edge device is infrequently or never updated and thus needs to last as long as possible.

Some edge devices run software in containers. Container systems provide the ability to run software with operating-system-level virtualization. Thus, different applications running in different containers can share operating system resources while at the same time seeming, to themselves, to own all resources of the entire operating system. Operating-system-level virtualization provides a great deal of flexibility regarding resource allocation for workloads running in containers.

Using container systems on resource-constrained edge devices has a number of drawbacks. First, container systems tend to write multiple copies of data to storage, which is antithetical to the edge device goals of hardware longevity because extra writes wear out storage devices faster. In addition, container systems perform a lot of automatic maintenance procedures that can put the system in an unknown state or cause it to run differently than it did yesterday, which is antithetical to the edge device goal of high availability and determinism. In addition, the act of running containers often involves unpacking archives and connecting to the Internet to download packages, which are both antithetical to the edge device goals of hardware longevity and determinism.

### SUMMARY

This specification describes systems and methods for implementing layered container software updates in resource-constrained edge devices. Using these techniques, a system can maintain a plurality of layered snapshots for launching containers that run software to control an industrial process using the edge device. By using the layered snapshot approach, the system can bypass the traditional container import process, which improves determinism and reliability while also saving wear-and-tear on the edge devices.

In some implementations, groupings of container software updates are applied to an edge device simultaneously. In some implementations, these software update groupings can include multiple software snapshots. In some cases, these snapshots can include updates to the container operating system as well as software updates to one or more applications running on the container. Given that resource-constrained edge devices can include multiple containers, in many circumstances these application software updates can include many redundant data features across containers operating within the edge device.

One of the objectives of this method is to layer these application software updates into aggregated groupings—“snapshots.” Snapshots are groupings of updates in the native format of the container-system. The “layering” of these updates into snapshots allows them to be written immediately to disk, without the need for an import process. This added efficiency reduces downtime and improves the reliability of implementing software updates. Additionally, the layering of updates can result in a reduction in file size due to the elimination of the intermediate step of writing the updates during the importing process. This reduction in file size can realize storage savings, which is especially important for resource-constrained edge devices where storage is limited, and the prospect of adding additional storage is either impossible or impractical. Additionally, the reduction in processing requirements by reducing the number of memory write operations is also especially beneficial for resource-constrained edge devices where the edge device hardware must last the lifetime of the machine it controls. By extending the lifetime of the edge device hardware, this can result in lower overall operating costs and prevent costly premature hardware failure.

Particular embodiments of the subject matter described in this specification can be implemented so as to realize one or more of the following advantages. Advantages can include increased revision control of software updates running on edge devices, improved protection for vulnerable software areas that may be accidentally overwritten or altered during a software update, increased flexibility to update software running on edge devices, the ability to directly implement updates without an importing process, improved lifetime of edge device components through a reduction in writing operations, improved storage capability through the reduction of redundant software constituents, the ability to quickly and efficiently “rollback” updates, and a reduction in edge device downtime associated with fixing software issues caused by software updates.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an overview of an example resource-constrained edge device and an operating environment.

FIG. 2 is a detailed view of an example snapshot.

FIG. 3 is a detailed view of an application snapshot.

FIG. 4A is a comparison of prior art solutions to the methods and systems described in this specification.

FIG. 4B is an example of how artifacts described in this specification can be organized.

FIG. 5 is an example process where snapshot updates are applied to one or more resource-constrained edge device containers.

### DETAILED DESCRIPTION

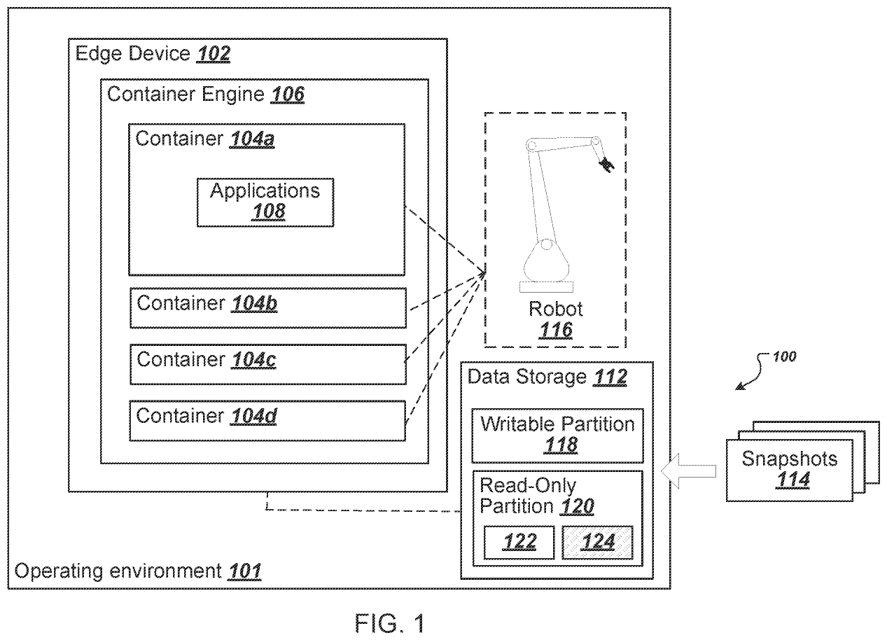

FIG. 1 is an overview 100 of an example resource-constrained edge device 102 and an operating environment 101.

The operating environment 101 includes one or more resource-constrained edge devices 102, one or more robots 116, one or more data storage devices 112, and a plurality of layered snapshot software updates 114. While data storage device 112 is shown separate from all other components, it should be understood that this component may be located in any component present in the operating environment 101, to include edge device 102.

The resource-constrained edge device 102 can execute a plurality of containers 104, each of which runs on top of a container engine 106, and a plurality of applications 108. These components are examples of components that could be utilized to implement the techniques described in this specification and are not meant to restrict the construction of container 104 to one particular embodiment.

In some implementations, container engine 106 is a runtime tool that executes basic functions of the containers 104. These operations can include running software programs and applications 108, writing updates to data storage 112, interfacing with the operating system 106, passing data values between different programs, and other operational functions. In some implementations, applications 108 can include instructions or programs which can effectuate different actions by a robot 116 within the operating environment 101. In some implementations, snapshots 114 provided to the data storage device 112 may be executed by the container 104 without performing a container import process. In some implementations, container 104 contains a “garbage collection” feature that deletes excess or unused data. In some cases, this garbage collection feature can be disabled to ensure that updated application 108 snapshots 114 are not deleted for applications 108 that may not currently be in use. In some implementations, edge devices 102 may need to operate for extended period of time without access to an external network, for example, the Internet. In some cases, the uploaded snapshots 114 can be executed by the container 104 without access to the Internet.

In some implementations, snapshots 114 are uploaded to data storage 112. In some cases, once uploaded to data storage 112 the snapshots 114 are executed by the containers 104. In some implementations, data storage 112 can contain different partitions to which the container 104 can view. In some cases, these partitions include a writable partition 118 and a read-only partition 120. In some cases, one or more of these partitions may be encrypted to protect the data contained within.

In some implementations, application 108 snapshots 114 are stored in the writable partition 118 of the data storage 112. In some cases, after receiving a new application 108 snapshot 114, the container 104 may overwrite the corresponding previous application 108 snapshot 114 stored on in the writable partition 118. In some cases, the container 104 may overwrite certain application 108 snapshots 114 while ignoring others within the writable partition 118, such that the other snapshots' 114 existing content is preserved. In some implementations, only a single copy of each application 108 snapshot 114 is written to the writable partition 118.

In some implementations, the read-only partition 120 is updated by a procedure during edge-device 102 start-up time. In some cases, this same procedure is not applied during edge device 102 runtime. In some implementations, the read-only partition 120 can contain multiple regions. In some cases, these regions can be one or more “active” regions 122 and one or more “inactive” regions 124. In some implementations, the operating system 106 snapshots 114 can be written to a specific inactive region of the read-only partition 120, for example, inactive region 124. Once written to the inactive region 124, the inactive region 124 containing the updated operating system 106 snapshot 114 may be re-designated, or “activated”, as an active region 122 and the associated containers' 104 operating system 106 can be restarted using the updated operating system 106 snapshot 114 in the now active region 122 of the read-only partition 120. In some cases, this process of updating the operating system 106 snapshots 114 can be conducted without modifying any of the application 108 snapshots 114.

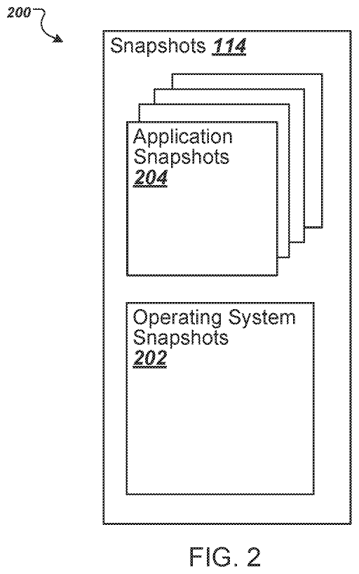

FIG. 2 is a detailed view 200 of an example snapshot 114. The example snapshot 114 includes an operating system snapshot 202 and a plurality of application snapshots 204. The operating system snapshots 202 and application snapshots 204 can be layered such that the footprint of the total snapshot 114 is minimized. While only a single operating system snapshot 202 and layered application snapshot 204 are shown, a snapshot 114 may contain a plurality of layered application snapshots 204.

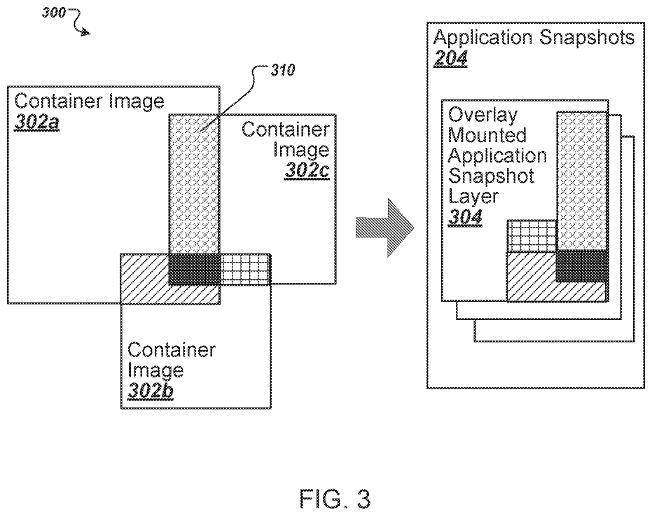

FIG. 3 is a detailed view 300 of an application snapshot 204. The example application snapshot 204 includes one or more overlay-mounted application snapshot layers 304. The detailed view 300 also includes a plurality of representative container images 302. Container images 302 are illustrated to provide a visual presentation of the described method of compressing application data and are not a part of application snapshot 204.

In some implementations, “overlay-mounted” refers to the layering of factory data with user data, such that the user data shadows the factory data within the snapshot. In this way, data in the overlay-mounted snapshots are presented to the container-system as a unified tree of container layers.

In some implementations, container images 302 can be a collection of metadata. In some cases, this metadata can be obtained from a plurality of separate entities and processed into an application snapshot 204. In some cases, this application metadata collection can be a collection of generic system applications and third-party applications.

In some implementations, the plurality of container images 302 can be processed prior to being uploaded to edge device 102 to layer their data into an application snapshot 204. As illustrated, regions of data within the plurality of application folders 302 is shared. For example, data region 310 is shared between application folder 302a and 302c. If these application folders were both uploaded to edge device 102, multiple copies of data region 310 would exist in storage. In addition to requiring more storage space, this duplication of data can also require more write operations of the edge device 102, reducing the life of edge device hardware components. By processing the plurality of application folders 302 into a layered application snapshot 204, shared regions of data, for example data region 310, are only uploaded to edge device 102 once.

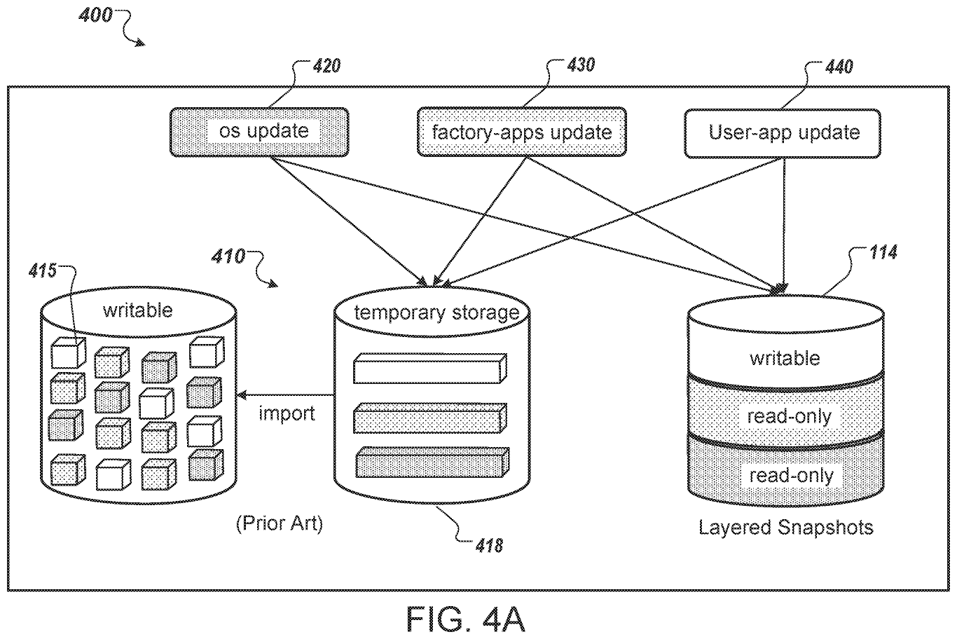

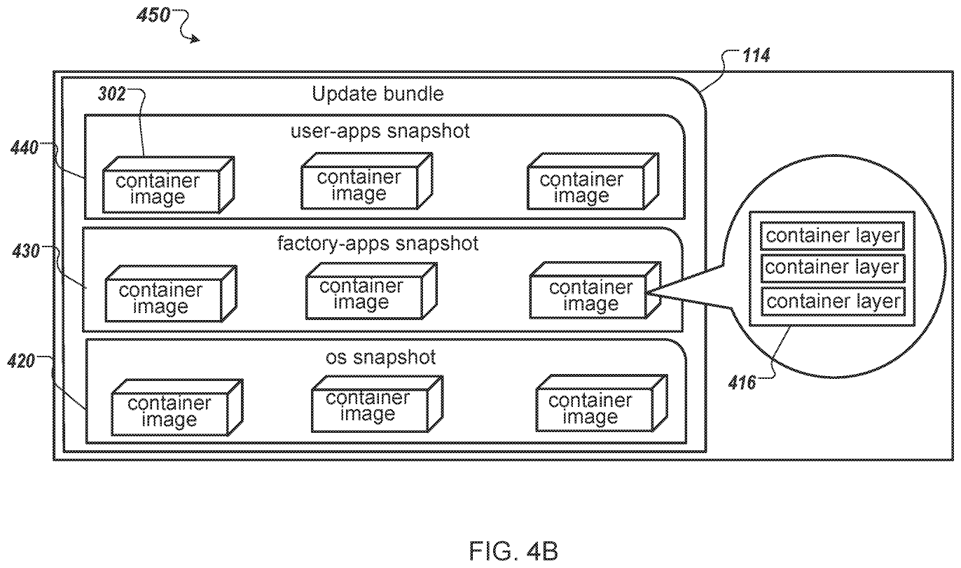

FIG. 4A is a comparison 400 of conventional container systems compared to the techniques described in this specification. The comparison 400 illustrates what happens during an operating system update 420, a factory application update 430, and a user application update 440. These updates affect layered snapshots 114 respective. This approach is different from conventional approaches in which different portions of data are read from temporary storage and are written multiple times in random locations on a storage device. As evident from the comparison 400, each of the updates 420, 430, and 440 are associated with a plurality of folders 415 present in the writable partition of the prior art solution 410. These folders 415 must be imported from temporary storage 418 prior to use.

In some implementations, layered snapshots 114 can compile the same information contained within the plurality of folders 415 into layers without requiring an import process. In some cases, the layers of snapshot 114 can include read-only and writable layers to ensure updates are implemented in such a way that they do not adversely impact other running applications or operating systems.

FIG. 4B is an example 450 of the methods and systems described in this specification. Similar to FIG. 4A, an operating system update 420, a factory application update 430, and a user application update 440 are illustrated together in a layered snapshot 114. Additionally, each update contains a plurality of container images 302. In some implementations, each container image includes a plurality of container layers 416 each associated with a container 104.

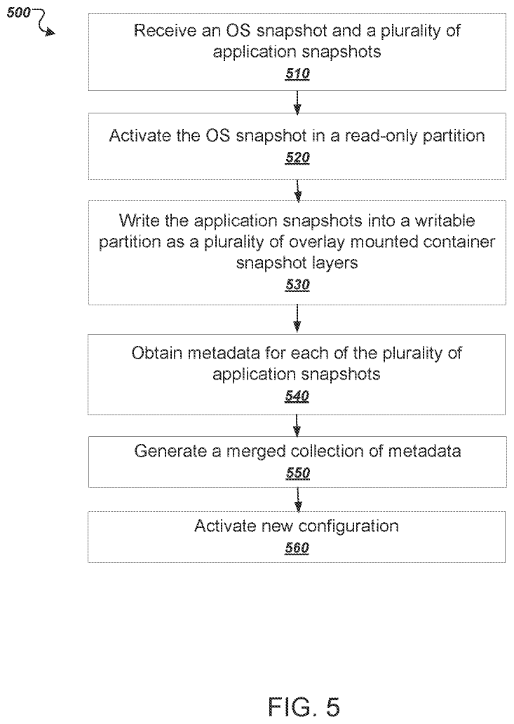

FIG. 5 is an example process 500 where snapshot updates are applied to one or more resource-constrained edge device containers.

In some implementations, the process 500 includes receiving an operating system snapshot and a plurality of application snapshots 510. While the process 500 describes one snapshot set, it should be understood that multiple snapshot sets may be provided at one time. In some implementations, these snapshots may be received by a storage structure within the container, for example, data storage 112 as described above.

In some implementations, the operating system snapshot is activated in a read-only partition within the storage structure 520. In some cases, the process of activating the operating system snapshot includes writing the operating system snapshot to an inactive partition. The container 104 can then be rebooted, and the previously inactive partition can be “activated” and designated as “read-only.”

In some implementations, the plurality of application snapshot layers are then written to a writable portion of the storage structure 530. The order in which snapshots are written in process 500 may take other forms, for example, writing the application snapshots to memory prior to writing the operating system snapshot.

In some implementations, metadata is obtained for the plurality of application snapshots 540. This metadata can then be merged into a single collection 550. In some implementations, once the metadata has been merged the new configuration is then activated 560.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computer-implemented method comprising:
receiving a plurality of container snapshots for operating an edge device, wherein the container snapshots include an operating system (OS) snapshot and a plurality of application snapshots;
activating the OS snapshot in a read-only partition;
writing the plurality of application snapshots into a writable partition as a plurality of overlay mounted container snapshot layers;
obtaining metadata for each of the plurality of application snapshots;
generating a merged collection of metadata using the metadata for each of the plurality of snapshots;
executing the OS snapshot including a container runtime tool; and
executing, using the container runtime tool, one or more containers using the plurality of overlay mounted container snapshot layers.

Embodiment 2 is the method of embodiment 1, further comprising updating a first application snapshot including:
receiving an updated container snapshot for the first application snapshot; and
overwriting the first application snapshot in the writable partition with the updated container snapshot.

Embodiment 3 is the method of embodiment 2, wherein updating the first application snapshot comprises updating the first application snapshot without modifying any of the other application snapshots in the writable partition.

Embodiment 4 is the method of embodiment 3, further comprising updating the OS snapshot including:
receiving an updated OS snapshot;
writing the updated OS snapshot into an inactive first region of the read-only partition;
activating the first region of the read-only partition; and
restarting the OS snapshot using the updated OS snapshot in the activated first region.

Embodiment 5 is the method of embodiment 4, wherein updating the OS snapshot comprises updating the OS snapshot without modifying any of the application snapshots in the writable partition.

Embodiment 6 is the method of embodiment 1, further comprising:
receiving application software from a plurality of different entities; and
processing the application software to generate each of the application snapshots that renders them overlay mountable.

Embodiment 7 is the method of embodiment 1, wherein writing the plurality of application snapshots into a writable partition as a plurality of overlay mounted container snapshot layers comprises writing only a single copy of each of the plurality of application snapshots into the writable partition.

Embodiment 8 is the method of embodiment 1, wherein executing the one or more containers using the plurality of overlay mounted container snapshot layers comprises directly executing the plurality of overlay mounted container snapshot layers without performing a container import process.

Embodiment 9 is the method of embodiment 1, further comprising disabling garbage collection functionality of the container runtime tool.

Embodiment 10 is the method of embodiment 1, wherein the OS snapshot and the plurality of application snapshots are disconnected from the Internet before execution.

Embodiment 11 is a system comprising:
one or more computers and one or more storage devices storing instructions that are operable, when executed by the one or more computers, to cause the one or more computers to perform operations comprising;
receiving a plurality of container snapshots for operating an edge device, wherein the container snapshots include an operating system (OS) snapshot and a plurality of application snapshots;
writing the OS snapshot into a read-only partition;
writing the plurality of application snapshots into a writable partition as a plurality of overlay mounted container snapshot layers;
obtaining metadata for each of the plurality of application snapshots;
generating a merged collection of metadata using the metadata for each of the plurality of snapshots;
executing the OS snapshot including a container runtime tool; and
executing, using the container runtime tool, one or more containers using the plurality of overlay mounted container snapshot layers.

Embodiment 12 is the system of embodiment 11, further comprising updating a first application snapshot including:
receiving an updated container snapshot for the first application snapshot; and
overwriting the first application snapshot in the writable partition with the updated container snapshot.

Embodiment 13 is the system of embodiment 12, wherein updating the first application snapshot comprises updating the first application snapshot without modifying any of the other application snapshots in the writable partition.

Embodiment 14 is the system of embodiment 13, further comprising updating the OS snapshot including:
receiving an updated OS snapshot;
writing the updated OS snapshot into an inactive first region of the read-only partition;
designating the first region of the read-only partition as the active region; and
restarting the OS snapshot using the updated OS snapshot in the first region.

Embodiment 15 is the system of embodiment 14, wherein updating the OS snapshot comprises updating the OS snapshot without modifying any of the application snapshots in the writable partition.

Embodiment 16 is the system of embodiment 11, further comprising:
receiving application software from a plurality of different entities; and
processing the application software to generate each of the application snapshots that renders them overlay mountable.

Embodiment 17 is the system of embodiment 11, wherein writing the plurality of application snapshots into a writable partition as a plurality of overlay mounted container snapshot layers comprises writing only a single copy of each of the plurality of application snapshots into the writable partition.

Embodiment 18 is the system of embodiment 11, wherein executing the one or more containers using the plurality of overlay mounted container snapshot layers comprises directly executing the plurality of overlay mounted container snapshot layers without performing a container import process.

Embodiment 19 is the system of embodiment 11, further comprising disabling garbage collection functionality of the container runtime tool.

Embodiment 20 is one or more non-transitory computer storage media encoded with computer program instructions that when executed by one or more computers cause the one or more computers to perform operations comprising:
receiving a plurality of container snapshots for operating an edge device, wherein the container snapshots include an operating system (OS) snapshot and a plurality of application snapshots;
writing the OS snapshot into a read-only partition;
writing the plurality of application snapshots into a writable partition as a plurality of overlay mounted container snapshot layers;
obtaining metadata for each of the plurality of application snapshots;
generating a merged collection of metadata using the metadata for each of the plurality of snapshots;
executing the OS snapshot including a container runtime tool; and
executing, using the container runtime tool, one or more containers using the plurality of overlay mounted container snapshot layers.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer-implemented method comprising:
receiving a plurality of container snapshots for operating an edge device, wherein the container snapshots include an operating system (OS) snapshot and a plurality of application snapshots;
activating the OS snapshot in a read-only partition;
writing the plurality of application snapshots into a writable partition as a plurality of overlay mounted container snapshot layers;
obtaining metadata for each of the plurality of application snapshots;
generating a merged collection of metadata using the metadata for each of the plurality of snapshots;
executing the OS snapshot including a container runtime tool; and
executing, using the container runtime tool, one or more containers using the plurality of overlay mounted container snapshot layers.

2. The method of claim 1, further comprising updating a first application snapshot including:
receiving an updated container snapshot for the first application snapshot; and
overwriting the first application snapshot in the writable partition with the updated container snapshot.

3. The method of claim 2, wherein updating the first application snapshot comprises updating the first application snapshot without modifying any of the other application snapshots in the writable partition.

4. The method of claim 3, further comprising updating the OS snapshot including:
receiving an updated OS snapshot;
writing the updated OS snapshot into an inactive first region of the read-only partition;
activating the first region of the read-only partition; and
restarting the OS snapshot using the updated OS snapshot in the activated first region.

5. The method of claim 4, wherein updating the OS snapshot comprises updating the OS snapshot without modifying any of the application snapshots in the writable partition.

6. The method of claim 1, further comprising:
receiving application software from a plurality of different entities; and
processing the application software to generate each of the application snapshots that renders them overlay mountable.

7. The method of claim 1, wherein writing the plurality of application snapshots into a writable partition as a plurality of overlay mounted container snapshot layers comprises writing only a single copy of each of the plurality of application snapshots into the writable partition.

8. The method of claim 1, wherein executing the one or more containers using the plurality of overlay mounted container snapshot layers comprises directly executing the plurality of overlay mounted container snapshot layers without performing a container import process.

9. The method of claim 1, further comprising disabling garbage collection functionality of the container runtime tool.

10. The method of claim 1, wherein the OS snapshot and the plurality of application snapshots are disconnected from the Internet before execution.

11. A system comprising:
one or more computers and one or more storage devices storing instructions that are operable, when executed by the one or more computers, to cause the one or more computers to perform operations comprising;
receiving a plurality of container snapshots for operating an edge device, wherein the container snapshots include an operating system (OS) snapshot and a plurality of application snapshots;
writing the OS snapshot into a read-only partition;
writing the plurality of application snapshots into a writable partition as a plurality of overlay mounted container snapshot layers;
obtaining metadata for each of the plurality of application snapshots;
generating a merged collection of metadata using the metadata for each of the plurality of snapshots;
executing the OS snapshot including a container runtime tool; and
executing, using the container runtime tool, one or more containers using the plurality of overlay mounted container snapshot layers.

12. The system of claim 11, further comprising updating a first application snapshot including:
receiving an updated container snapshot for the first application snapshot; and
overwriting the first application snapshot in the writable partition with the updated container snapshot.

13. The system of claim 12, wherein updating the first application snapshot comprises updating the first application snapshot without modifying any of the other application snapshots in the writable partition.

14. The system of claim 13, further comprising updating the OS snapshot including:
receiving an updated OS snapshot;
writing the updated OS snapshot into an inactive first region of the read-only partition;
designating the first region of the read-only partition as the active region; and
restarting the OS snapshot using the updated OS snapshot in the first region.

15. The system of claim 14, wherein updating the OS snapshot comprises updating the OS snapshot without modifying any of the application snapshots in the writable partition.

16. The system of claim 11, further comprising:
receiving application software from a plurality of different entities; and
processing the application software to generate each of the application snapshots that renders them overlay mountable.

17. The system of claim 11, wherein writing the plurality of application snapshots into a writable partition as a plurality of overlay mounted container snapshot layers comprises writing only a single copy of each of the plurality of application snapshots into the writable partition.

18. The system of claim 11, wherein executing the one or more containers using the plurality of overlay mounted container snapshot layers comprises directly executing the plurality of overlay mounted container snapshot layers without performing a container import process.

19. The system of claim 11, further comprising disabling garbage collection functionality of the container runtime tool.

20. One or more non-transitory computer storage media encoded with computer program instructions that when executed by one or more computers cause the one or more computers to perform operations comprising:
receiving a plurality of container snapshots for operating an edge device, wherein the container snapshots include an operating system (OS) snapshot and a plurality of application snapshots;
writing the OS snapshot into a read-only partition;
writing the plurality of application snapshots into a writable partition as a plurality of overlay mounted container snapshot layers;
obtaining metadata for each of the plurality of application snapshots;
generating a merged collection of metadata using the metadata for each of the plurality of snapshots;
executing the OS snapshot including a container runtime tool; and
executing, using the container runtime tool, one or more containers using the plurality of overlay mounted container snapshot layers.
